(19) United States
(12) Patent Application Publication
(10) Pub. No.: US 2006/0110524 A1
(43) Pub. Date: May 25, 2006

(54) Additives and modified tetrabasic sulfate crystal positive plates for lead acid batteries

(75) Inventors: Lu Zhang, Carmel, IN (US); Douglas R. Davenport, New Castle, IN (US); Jason E. Connell, Cicero, IN (US)

Correspondence Address: FOLEY & LARDNER LLP, 777 EAST WISCONSIN AVENUE, SUITE 3800, MILWAUKEE, WI, 53202-5308, US

(73) Assignee: Delphi Technologies, Inc., Troy, MI (US)

(21) Appl. No.: 10/992,987

(22) Filed: Nov. 19, 2004

(51) Int. Cl. B05D 5/12

(52) U.S. Cl. 427/58

(57) ABSTRACT

A positive electrode plate-making process for a lead acid battery that produces an active material precursor comprising tetrabasic lead sulfate crystals with an average crystal width less than 20 μm. The process includes mixing a lead and/or lead oxide powder and a paste additive with sulfuric acid to form a positive electrode paste composition, wherein the paste additive comprises ground tetrabasic lead sulfate crystals having an average particle size in the range of 1-20 μm. The paste is then cured on a positive battery grid to form a positive electrode plate having the desired active material precursor containing tetrabasic lead sulfate crystals with an average crystal width less than 20 μm. In an embodiment, curing is performed directly after applying the paste to the grid, with no intermediate steaming process.

### TECHNICAL FIELD

This invention relates to batteries, and more particularly to a paste composition for lead acid batteries.

### BACKGROUND OF THE INVENTION

Lead acid batteries are the oldest and best-known energy devices in automobile applications. The structure of the positive plate of a lead acid battery is a primary factor affecting its life and its current generating efficiency. Lead dioxide is employed as the active positive material. Typically, a paste of a precursor to the lead dioxide is applied to a lead grid to make the positive plate. The precursor is then electrochemically oxidized to the lead dioxide.

A common process to manufacture a positive plate for a lead acid battery includes mixing a lead-based powder with water and H₂SO₄ under constant stirring and optionally at an elevated temperature. The lead-based powder generally comprises lead and/or lead oxide powders, such as PbO and Pb₃O₄. Depending on the ratio of starting materials, the rate of mixing and the temperature, the paste formed from the mixing step contains mixtures of the initial powders, lead sulfate, and basic lead sulfates such as PbOPbSO₄ (monobasic lead sulfate), 3PbOPbSO₄.H₂O (tribasic lead sulfate), and 4PbOPbSO₄ (tetrabasic lead sulfate).

After a period of mixing, the paste is applied to a grid by a specially designed machine to prepare the positive plate. To prevent sticking of the plates, the positive plates are surface dried in an oven prior to stacking them on skids. To improve the active material/grid contact and the mechanical strength of the active material, the skids with positive plates are subjected to a steaming and curing process, which includes transporting the positive plates to a steam chamber for several hours and then to a curing room. By way of example, steaming may be conducted at 100° C. and 100% relative humidity for 1-24 hours, and curing may be performed at 45-80° C. for 12-96 hours with the humidity absent (0%) or decreasing from 100% to 0%, without control. During steaming and curing, further reaction of the ingredients occurs, resulting in a different ratio of the lead oxides, sulfate and basic lead sulfates. The resulting cured material is a precursor to lead dioxide (PbO₂), which forms the active material in the plates.

After curing is complete, negative plates and the positive plates are assembled to form a green battery. A formation step is then performed to electrochemically oxidize the precursor material for the positive electrode to lead dioxide and for the negative electrode to sponge lead, typically by adding sulfuric acid into the assembled cells. A finishing step includes dumping the forming acid, refilling the batteries with the shipping acid, and sealing the batteries with a final cover.

Tetrabasic lead sulfate, referred to herein as 4BS, which crystallizes as large elongated prismatic (needle shape) crystals, undergoes anodic conversion to PbO₂ without losing the prismatic structure. Because of its interlocking needle-shaped structure, the 4BS provides the necessary mechanical strength for the positive plates, and thus better durability performance for lead acid batteries. The crystal size of the 4BS crystal structure, defined as the crystal width, is one of the key factors affecting the performance of the positive plate. In the conventional plates described above, the typical crystal sizes randomly range from 15 μm to 40 μm. Lead acid batteries for deep cycling are generally manufactured with a large amount of these large 4BS crystals in the active material at the end of the curing process to provide the strength to the positive electrode during battery use. However, formation of these large crystals is inefficient, and their utilization (capacity per gram of active material) is lower than other oxides.

Thus, although prismatic crystals of 4BS improve the adhesion and strength of the active material during use, their performance has not been entirely satisfactory. It has been determined that decreasing the crystal size, i.e., the crystal width, can allow for more efficient conversion to lead dioxide from the precursor, as well as enhanced adhesion and increased current capacity.

In U.S. Pat. Nos. 5,660,600 and 5,273,554, the crystal size of the 4BS is reduced by reacting the lead oxide powder with sulfuric acid in the presence of an excess of sulfate, such as by adding sodium sulfate, to form the paste. Either the reaction temperature or the curing temperature must exceed 60° C. to form the small 4BS crystals.

There is a further need for methods of reducing the 4BS size in positive plates of lead acid batteries, and particularly in a way that simplifies the method for making the positive plates.

### SUMMARY OF THE INVENTION

The present invention provides a positive electrode plate-making process for a lead acid battery that produces an active material precursor comprising tetrabasic lead sulfate crystals with an average crystal width less than 20 μm. The process includes mixing a lead-based powder (for example lead and/or lead oxide) and a paste additive with sulfuric acid to form a positive electrode paste composition, wherein the paste additive comprises ground tetrabasic lead sulfate crystals having an average particle size in the range of 1-20 μm. The paste is then applied to a positive battery grid and cured to form a positive electrode plate for the lead acid battery having the desired active material precursor containing tetrabasic lead sulfate crystals with an average crystal width less than 20 μm. In an embodiment, curing is performed directly after applying the paste to the grid, with no intermediate steaming process. In another embodiment, the paste additive is used in an amount of 0.001-3 wt. %, for example, 0.001-1 wt. %, and by further example, 0.05-1 wt. %. In yet another embodiment, the lead-based powder comprises Pb powder, PbO powder, and Pb₃O₄ powder.

### BRIEF DESCRIPTION OF THE DRAWINGS

The present invention will now be described, by way of example, with reference to the accompanying drawings, in which:

FIGS. 1A-1D are micrographs at 500× magnification depicting the crystal size of 4BS crystals with no additives in accordance with the prior art, and with varying amounts of additives in accordance with the present invention.

FIG. 2A is a graph of 4BS crystal width and BET specific surface area as a function of the percentage of a 4BS additive in accordance with the present invention.

FIG. 2B is a graph of 4BS crystal width as a function of the percentage of different types of additives.

FIG. 2C is a graph of 4BS crystal width as a function of the percentage of 4BS additive in accordance with the present invention.

FIG. 3 is a graph of the amount of 4BS in the positive plate active material precursor as a function of curing temperature for a prior art paste and pastes of the present invention.

FIG. 4 is a graph of the amount of free lead as a function of the percentage of 4BS additive in accordance with the present invention.

FIG. 5 is a graph of the as-received RC capacity as a function of the percentage of 4BS additive in accordance with the present invention.

### DETAILED DESCRIPTION

The present invention provides a method for making positive battery plates for a lead acid battery having 4BS crystals with an average width less than 20 μm. To that end, a lead-based powder and a paste additive are reacted with sulfuric acid to form a positive electrode paste composition. The lead-based powder comprises lead and/or lead oxide. As used herein, “lead oxide” refers to any one or any combination of lead monoxide (PbO), lead suboxide (Pb₂O), lead trioxide (Pb₂O₃), and lead tetroxide (Pb₃O₄), although PbO and Pb₃O₄ are most commonly used. The paste additive comprises ground tetrabasic lead sulfate (4BS) crystals having an average particle size in the range of 1-20 μm. In one embodiment of the present invention, the paste additive comprises 0-75 wt. % lead oxide and 25-100 wt. % ground 4BS crystals having an average particle size in the range of 1-20 μm. In another embodiment, the paste additive contains no lead oxide. The mixing with sulfuric acid may be performed with constant stirring. An elevated temperature during stirring is optional. In one embodiment, the paste additive may be added in an amount of 0.001-3 wt. % of the lead oxide powder. In an exemplary embodiment, the paste additive is added in an amount of 0.05-1 wt. %. The positive electrode paste composition is then applied to a positive battery grid and cured to form a positive electrode plate. The cured positive active material precursor, by virtue of the present invention, has an average crystal width less than 20 μm. In an exemplary embodiment, the average crystal width is 10 μm or less.

By using the paste additive in the reaction step, 4BS seeds are provided as nucleation sites for 4BS crystals. Because of these nucleation sites, the conversion of lead oxide to 4BS occurs more quickly and efficiently than in the absence of the nucleation seeds, and smaller crystal sizes are achieved. Only a very small amount of the 4BS seeds are needed, on the order of 0.001-1 wt. %, to achieve the nucleation affect. In an exemplary embodiment, 0.05-1 wt. % of the additive seeds is used. Above 1 wt. %, there does not appear to be any additional decrease in 4BS crystal size in the resulting cured active metal precursor. However, an increase in surface area of the crystals may be achieved at higher amounts, such as 1-2 wt. % or greater.

Because of the paste additive, positive electrode plates can be developed without the steaming process used in many prior art plate-making processes. The steaming process is used to convert simple lead sulfate to tetrabasic lead sulfate. However, in the present invention, the lead oxide is converted directly to 4BS rather than to the simple lead sulfate, such that the steaming process may be eliminated. Thus, directly after the positive electrode paste is applied to the positive battery grid, the paste may be cured. In addition, mixing of the components may be at ambient temperature and the curing time and/or temperature may be reduced. By way of example, after mixing with constant stirring at ambient temperature, the positive electrode paste composition is applied to the grid and may be cured at 40-80° C. for 12-96 hours with a controlled relative humidity of 100% or less, for example 80% or less, followed by drying at 0% relative humidity. In an exemplary embodiment, curing is performed at 45-60° C. In a further exemplary embodiment, curing is performed at 45-55° C.

The paste additive may be achieved by grinding 4BS crystals to the desired size by any known grinding process. It may be appreciated that the ground 4BS crystals may be produced by a chemical conversion from lead and/or lead oxide and sulphuric acid, followed by grinding, such that some unreacted lead oxide may be mixed with the 4BS crystals that are ground to form the paste additive. Thus, while a paste additive of 100% ground 4BS crystals is desirable, it may be appreciated that the additive may contain 0-25 wt. % unreacted lead oxide, and may also contain unreacted lead.

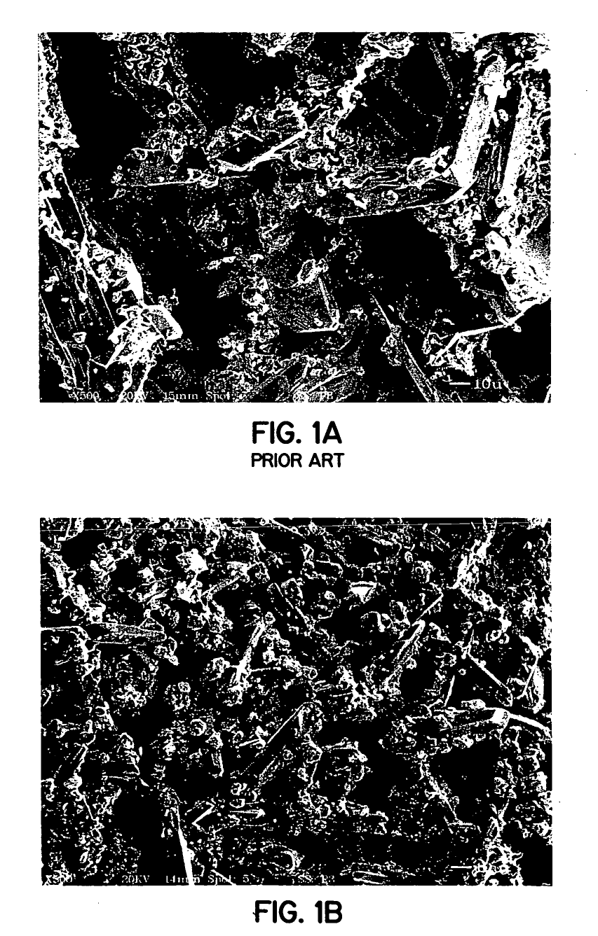

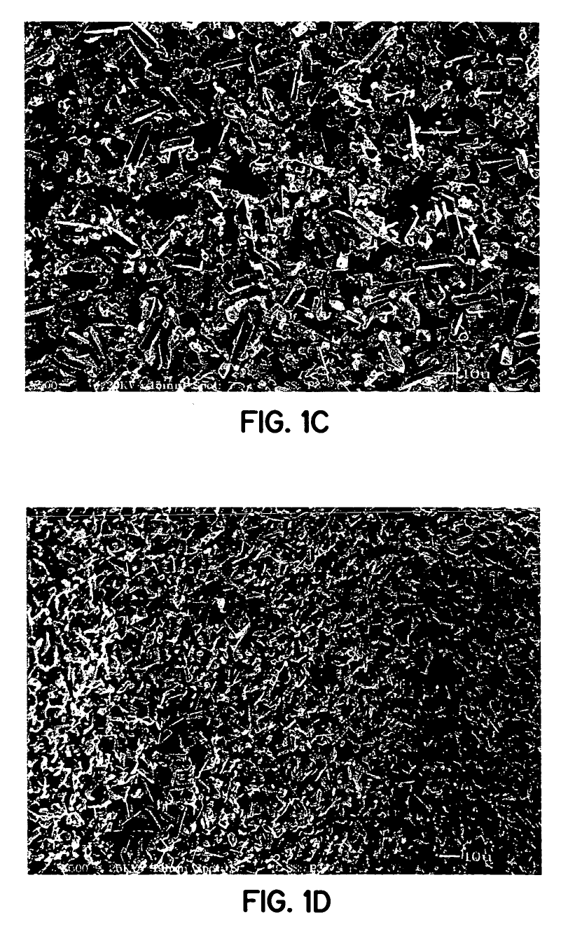

FIG. 1A is a micrograph depicting a cured positive active material of the prior art made by reacting lead-based powder with sulfuric acid, followed by steaming the paste at 100° C. and 100% relative humidity (RH) for three hours, and then curing was performed for 48 hours at 60° C. With 0% paste additive, the average crystal width of the 4BS crystals is approximately 23 μm.

In FIG. 1B, 0.005 wt. % paste additive was included in the reaction mixture. The steaming process was not necessary in preparing the paste of the present invention, and curing was performed for 48 hours at 60° C. The average crystal width of the 4BS crystals in the cured positive active material precursor was reduced to 10 μm.

In FIG. 1C, the positive plate was prepared in the same manner as in FIG. 1B, but 0.05 wt. % of the paste additive was included in the reaction mixture. The crystal width was reduced further to 5 μm.

FIG. 1D is a micrograph of a positive active material precursor, also prepared in the same manner as the active material precursor in FIG. 1B, but using 1 wt. % paste additive in accordance with the present invention. The average crystal size was even further reduced to about 2 μm. It may also be observed from the micrographs in FIGS. 1A-1D that the prior art method produced crystal widths in a large range, generally between 15-40 μm. With the paste additive of the present invention, the range of crystal widths became narrower with increasing amounts of the 4BS paste additive, such that the method of the present invention achieves a smaller average crystal width as well as a more narrow distribution of crystal widths throughout the active material precursor.

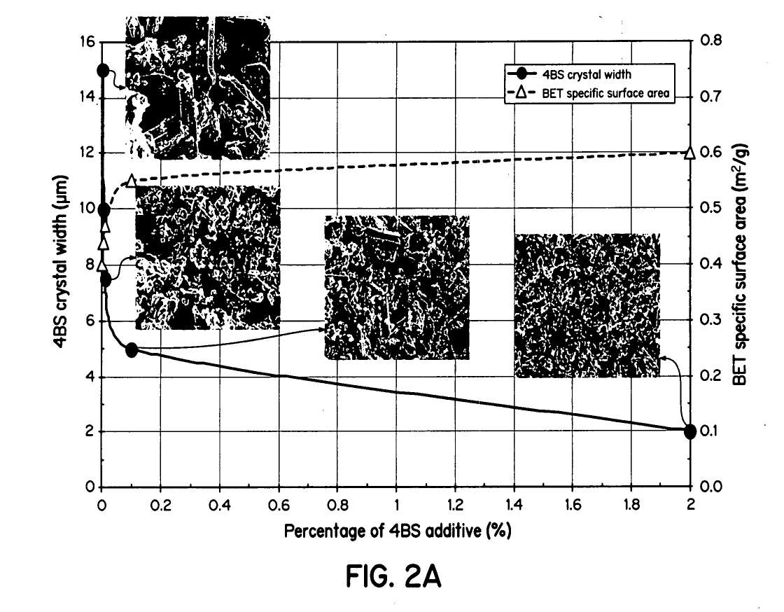

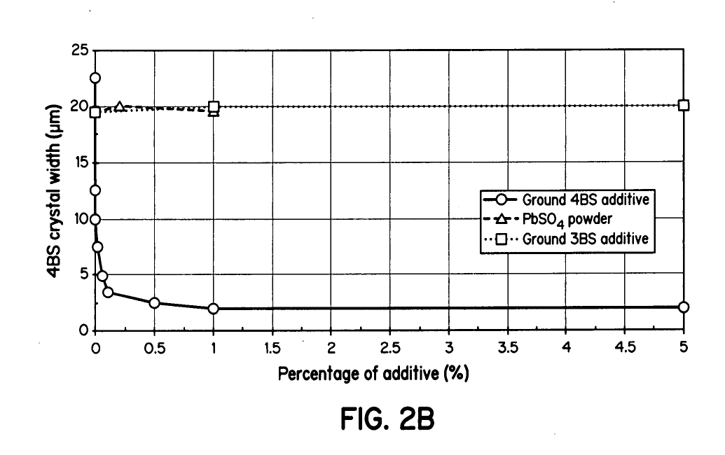

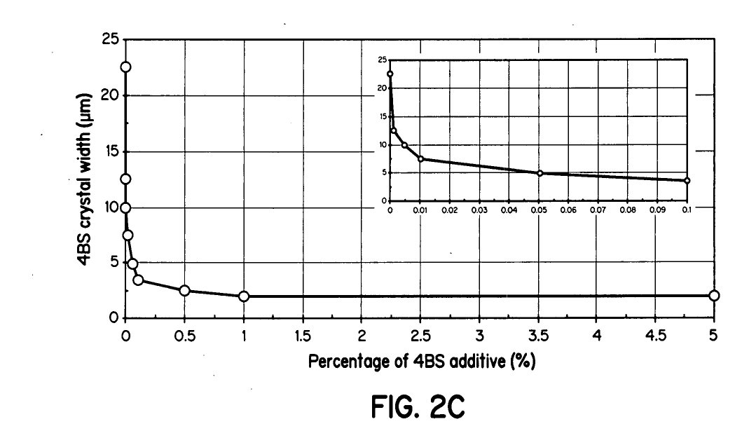

FIG. 2A is a plot of the 4BS average crystal width and the BET specific surface area in the cured positive active material precursor as a function of the percentage of the paste additive. In this example, preparation of the control sample of the prior art was carried out under conditions that achieved a 15 μm average crystal width and a 0.4 m²/g BET specific surface area in the cured sample. As the percentage of 4BS additive increased, the average crystal width decreased and the BET specific surface area increased. Again, the steaming process was not necessary in preparing the pastes of the present invention, whereas the steaming process was necessary in the prior art control sample. A micrograph is also provided for the control sample and three of the four test samples, namely those having 0.05, 0.1 and 2 wt. % of the additive. Any increase in the surface area improves the formation efficiency for the battery, as will be explained in further detail below.

FIG. 2B is a graph of the average 4BS crystal width in the active material precursor as a function of the percentage of additive, for the 4BS additive in accordance with the present invention. For comparative purposes, a basic lead sulfate powder (PbSO₄) and a ground tribasic lead sulfate (3BS) additive were also used to determine their affect as a paste additive. While the ground 4BS additive in accordance with the present invention achieved a significant reduction in average crystal size, the addition of basic lead sulfate and ground tribasic lead sulfate seeds had no effect on the average crystal width. In other words, the simple lead sulfate and the tribasic lead sulfate did not act as nucleants for the 4BS lead crystals.

FIG. 2C is a graph of the 4BS average crystal width as a function of the percentage of the 4BS additive with a blow-up of the graph for very low contents of the 4BS additive. FIG. 2C shows that even very small amounts of the 4BS additive have a drastic affect on the average crystal width of the 4BS crystals in the cured active material precursor. FIG. 2C further demonstrates that amounts greater than 1-2 wt. % of the paste additive show no further improvement in the crystal width reduction. However, referring to FIG. 2A, additional BET specific surface area increase may be achieved in the 1-2 wt. % or greater range of 4BS paste additive addition.

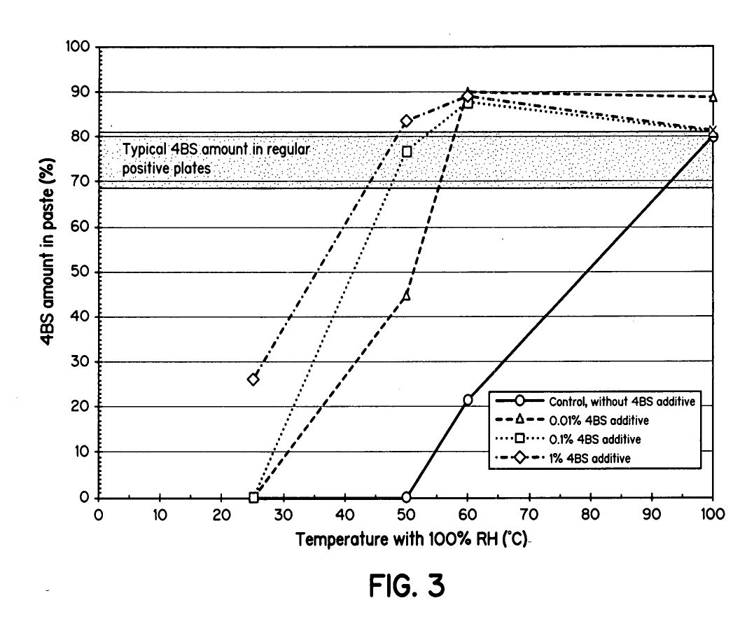

FIG. 3 is a graph of the amount of 4BS crystals in the active material precursor as a function of the curing temperature with 100% relative humidity (RH) for a control sample having no paste additive, and samples of the present invention containing 0.01 wt. %, 0.1 wt. % and 1 wt. % 4BS additives. In the absence of the steaming step, FIG. 3 shows that very high curing temperatures, i.e., 90-100° C., are needed for the control sample to achieve a desired amount of 4BS crystals in the active material precursor of the positive plate. The desired amount is generally at least about 69% in this example, and typical active material precursors include 69-81%. For the method of the present invention in which 0.01 wt. % 4BS paste additive was used, a curing temperature, without a prior steaming step, achieved the minimum desired 4BS amount at a curing temperature of 55° C. At a curing temperature of 60° C., approximately 90% 4BS crystals were formed in the active material precursor, which exceeds the typical amounts present in current positive electrode plates. For the positive electrode plate of the present invention in which 0.1 wt. % 4BS paste additive was used, the minimum desired 4BS amount in the active material precursor was achieved at a curing temperature of only 47° C. without a prior steaming step. Curing at 60° C. resulted in about 88% 4BS crystals in the active material precursor, which also significantly exceeds the typical amount present in current positive electrode plates. For a positive electrode plate of the present invention in which 1 wt. % 4BS paste additive was used, the minimum desired 4BS amount was achieved at only 43° C. The typical amount of 4BS is exceeded at a curing temperature of about 48° C., and a curing temperature of 60° C. achieves approximately 89% 4BS crystals in the active material precursor. Thus, curing temperatures in the range of 40-60° C. may be effective, even without a prior steaming step to achieve typical or even greater amounts of 4BS crystals in the active material precursor and with smaller average crystal sizes than in current positive electrode plates.

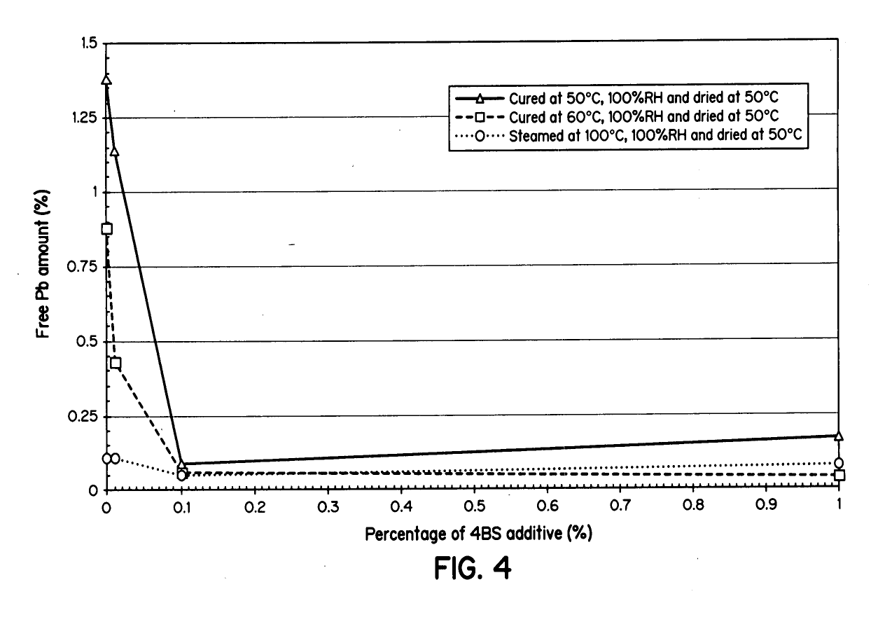

FIG. 4 depicts the amount of free lead present in the active material precursor as a function of the amount of paste additive, for various curing procedures. It may be appreciated that the amount of free lead is desired to be as low as possible. When the positive electrode paste is steamed at 100° C. at 100% relative humidity and then cured at 50° C., the amount of free lead is kept at a minimum with or without the 4BS paste additive of the present invention. If, however, the steaming step is eliminated, and the positive electrode paste is cured at 50° C. at 100% relative humidity and dried at 50° C., the amount of free lead is relatively high when no paste additive is present in the composition. If only 0.01 wt. % paste additive is included, curing at 50° C. still leaves a relatively high amount of free lead unreacted in the active material precursor. If, however, the paste additive content is increased to 0.1 wt. %, 50° C. curing is effective to achieve a low free lead content. When the steaming process is eliminated and the positive electrode paste is cured at 60° C. at 100% relative humidity and dried at 50° C., a high free lead content is present when no paste additive is used in the reaction mixture. Use of even 0.01 wt. % paste additive achieves a significant reduction in the amount of free lead at the 60° C. curing temperature. Again, 0.1 wt. % paste additive or greater achieves a very low free lead content.

As can be discerned from the above, an active material precursor having a desired amount of small crystal size 4BS and low free lead content can be achieved by use of the ground 4BS crystals in the paste mixture and subsequently curing at 40-60° C., for example below 60° C. Curing may be at 100% RH, or at 80% RH or less. In addition, the steaming process may be eliminated.

As discussed in the Background, formation includes electrochemically oxidizing the cured material, referred to as the active material precursor, to lead dioxide. The electrochemical oxidation may be achieved with one or more cycles of Ah (amps×hours) input. The present invention may achieve a reduction in the Ah input, both with respect to the number of amps and the number of hours.

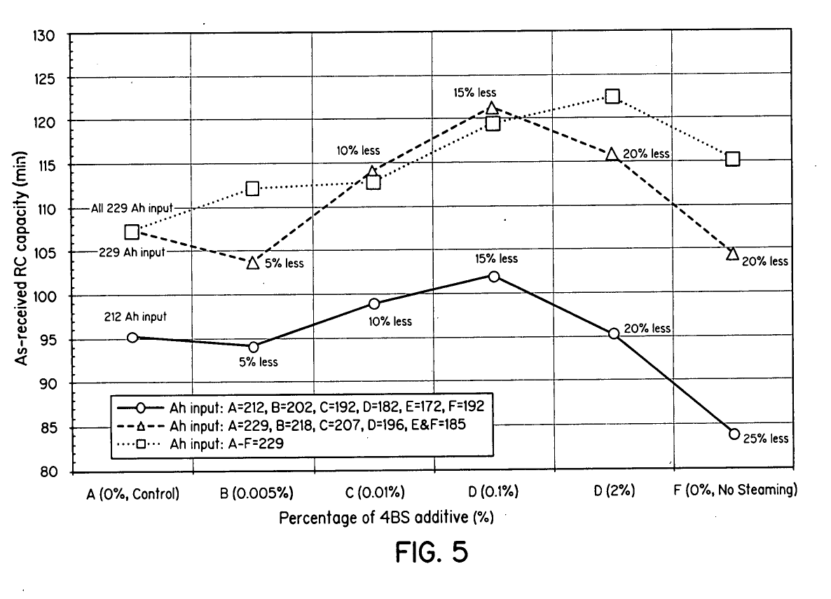

FIG. 5 depicts the as-received RC capacity as a function of the percentage of 4BS additive used in making the positive electrode plates. A Control Sample A was tested having 0 wt. % additive paste, wherein the 4BS crystals are formed by a steaming process. Test Plates B-E were tested having 0.005 wt. %, 0.01 wt. %, 0.1 wt. % and 2 wt. % paste additive in accordance with the present invention, wherein the steaming process was estimated. A Comparative Sample F was also tested having 0% paste additive and tribasic lead sulfate crystals that were not converted to 4BS by steaming. Each of the Plates A-F were formed with an Ah input of 229, and FIG. 5 shows an increase in the as-received RC capacity with increasing levels of paste additive in accordance with the present invention. The same plates were tested, but with the Ah input decreasing with increasing content of the paste additive. Specifically, Test Plate B containing 0.05 wt. % paste additive received 5% less Ah input. Test Plate C, which contained 0.01 wt. % paste additive, received 10% less Ah input. Test Plate D, which contained 0.1 wt. % paste additive, received 15% less Ah input. Test Plate E and Comparative Plate F each received 20% less Ah input. Test Plates C, D and E each achieved a higher RC capacity than the Control Sample. Each of Plates A-F was again tested, all receiving a lower Ah input. The Control Plate A received a 212 Ah input. Test Plates B-E received 5%, 10%, 15% and 20%, respectively, less Ah input than Control Plate A. Comparative Plate F received 25% less Ah input. Test Plates C and D achieved a higher RC capacity, even with the lower Ah input, than the Control Plate A. Test Plate E, which received 20% less Ah input than the Control Plate A, achieved the same RC capacity as the Control Plate A. For the Comparative Plate F, although the higher RC capacity was achieved compared to the Control Plate A at an equivalent Ah input, lowering the Ah input resulted in a lower RC capacity than the Control Plate A. Therefore, only the 4BS paste additive in accordance with the present invention allows for an increase in reserve capacity at lower Ah inputs.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention is therefore not limited to the specific details, representative apparatus and method and illustrative examples shown and described. Accordingly, departures may be made from such details without departing from the scope of the general inventive concept.

1. A positive electrode plate-making process for a lead acid battery, comprising:
mixing a lead-based powder and a paste additive with sulfuric acid to form a positive electrode paste composition, wherein the paste additive comprises ground tetrabasic lead sulfate crystals having an average particle size in the range of 1-20 μm;
applying the positive electrode paste composition onto a positive battery grid; and
curing the positive electrode paste composition to form a positive electrode plate for the lead acid battery having an active material precursor comprising tetrabasic lead sulfate crystals with an average crystal width less than 20 μm.

2. The process of claim 1 wherein the mixing includes 0.001-1 wt. % of the paste additive.

3. The process of claim 1 wherein the mixing includes 0.05-1 wt. % of the paste additive.

4. The process of claim 1 wherein the paste additive comprises 0-75 wt. % lead oxide and 25-100 wt. % of the tetrabasic lead sulfate crystals.

5. The process of claim 1 wherein curing is performed at 40-80° C. for 12-96 hours at 100% or less relative humidity.

6. The process of claim 1 wherein curing is performed at 45-60° C.

7. The process of claim 1 wherein curing is performed at 45-55° C.

8. The process of claim 1 wherein the curing is performed directly after the applying, with no intermediate steaming process.

9. The process of claim 1 wherein the lead-based powder comprises lead or a lead oxide, or a combination thereof.

10. A positive electrode plate-making process for a lead acid battery, comprising:
mixing a lead-based powder and 0.001-3 wt. % of a paste additive with sulfuric acid to form a positive electrode paste composition, wherein the lead-based powder comprises lead or lead oxide, or a combination thereof, and wherein the paste additive comprises ground tetrabasic lead sulfate crystals having an average particle size in the range of 1-20 μm;
applying the positive electrode paste composition onto a positive battery grid; and
directly thereafter, curing the positive electrode paste composition at 40-80° C. for 12-96 hours to form a positive electrode plate for the lead acid battery having an active material precursor comprising tetrabasic lead sulfate crystals with an average crystal width less than 20 μm.

11. The process of claim 10 wherein the mixing includes 0.001-1 wt. % of the paste additive.

12. The process of claim 10 wherein the mixing includes 0.05-1 wt. % of the paste additive.

13. The process of claim 10 wherein the paste additive comprises 0-75 wt. % lead oxide and 25-100 wt. % of the tetrabasic lead sulfate crystals.

14. The process of claim 10 wherein curing is performed at 100% relative humidity.

15. The process of claim 10 wherein curing is performed at 80% or less relative humidity.

16. The process of claim 10 wherein curing is performed at 45-60° C.

17. The process of claim 10 wherein curing is performed at 45-55° C.

18. A positive electrode plate-making process for a lead acid battery, comprising:
mixing together water, a Pb-based powder comprising Pb powder, PbO powder, and Pb₃O₄ powder, 0.001-1 wt. % of a paste additive relative to the Pb-based powder content, and sulfuric acid to form a positive electrode paste composition, wherein the paste additive comprises 0-75 wt. % lead oxide and 25-100 wt. % ground tetrabasic lead sulfate crystals having an average particle size in the range of 1-20 μm;
applying the positive electrode paste composition onto a positive battery grid; and
directly thereafter, curing the positive electrode paste composition at a temperature less than 80° C. to form a positive electrode plate for the lead acid battery having tetrabasic lead sulfate crystals with an average crystal width less than 20 μm.

19. The process of claim 18 wherein curing is performed at 100% relative humidity.

20. The process of claim 18 wherein curing is performed at 80% or less relative humidity.

21. The process of claim 18 wherein curing is performed at 45-60° C.

22. The process of claim 18 wherein curing is performed at 45-55° C.
